(19) United States
(12) Patent Application Publication
(10) Pub. No.: US 2005/0064835 A1
(43) Pub. Date: Mar. 24, 2005

(54) Audio system responsive to incoming phone calls

(75) Inventors: Carl Phillip Gusler, Austin, TX (US); Rick Allen Hamilton II, Charlottesville, VA (US); James Wesley Seaman, Falls Church, VA (US)

Correspondence Address: IBM CORPORATION (DWL);C/O LALLY & LALLY, L.L.P., P. O. BOX 684749, AUSTIN, TX, 78768-4749, US

(73) Assignee: International Business Machines Corporation

(21) Appl. No.: 10/666,867

(22) Filed: Sep. 18, 2003

(51) Int. Cl. H04B 1/06; H04B 7/00

(52) U.S. Cl. 455/245.1; 455/230

(57) ABSTRACT

A motor vehicle includes an audio system and a control system configured to mute the audio system output automatically in response to input signals indicating an incoming call to any of two or more recognized cell phones or pagers. A digital input implementation employs a wire or cable from the cell phone directly to the control system. The cable carries a signal that is asserted whenever an incoming call is detected. An audio input implementation uses a set of audio detectors throughout the vehicle. The control system is “trained” to listen for a cell phone ring that matches any of a list of previously learned cell phone rings. The control system may support infrared and radio frequency implementations as well. In another embodiment, the control system detects the incoming call through the motor vehicle's external antenna in parallel with the detection of the incoming call by the cell phone.

### BACKGROUND

1. Field of the Present Invention

The present invention is in the field of electronic equipment for use in conjunction with audio systems such as an audio system in a motor vehicle.

2. History of Related Art

People in general and business professionals in particular spend a significant amount of time in their motor vehicles. During much of this time, many people use their audio systems for listening to radio, CD's, books on tape, and the like. Simultaneously, cellular telephone and wireless paging services are now so pervasive that a large percentage of vehicles on the road have one or more cellular telephones and/or wireless pagers in them all or most of the time and many business professionals now routinely conduct business using their cell phones while driving in their own vehicles or riding in colleagues' vehicles.

A problem arises when a wireless device such as a cellular phone and/or wireless pager device that is inside a vehicle rings or is otherwise activated while the vehicle's audio system is on. The owner of the ringing or beeping wireless device may not hear the tone at all or in time to respond to it after turning the audio system down or off. Perhaps as significant, safety issues may be raised when a driver reacts to an incoming call or page by quickly turning his or her attention to the audio system in an effort to answer the call promptly without subjecting the caller to the driver's personal listening preferences. It would be desirable to implement a system in which audio systems and cellular telephones cooperate to prevent, as desired, simultaneous use of both.

### SUMMARY OF THE INVENTION

The problem identified above is addressed by a system and a motor vehicle according to the present invention. The motor vehicle includes an audio system and a control system configured to mute the audio system output automatically in response to input signals indicating an incoming call on an authorized or recognized cell phone or pager. The incoming call may be detected in various ways. A digital input implementation employs a wire or cable connecting the wireless device directly to a digital input port of the control system. The cable carries a signal that is asserted whenever an incoming call is detected. An audio input implementation uses a set of audio detectors throughout the vehicle. The control system is “trained” to listen for a wireless device ring that matches any of a list of previously learned cell phone rings. The control system may support infrared and radio frequency implementations as well. In another embodiment, the control system detects the incoming call through the motor vehicle's external antenna in parallel with the detection of the incoming call by the wireless device. In any of these implementations, the control system is configured to assert a mute signal upon detecting an incoming call to a recognized or authorized wireless device.

### BRIEF DESCRIPTION OF THE DRAWINGS

Other objects and advantages of the invention will become apparent upon reading the following detailed description and upon reference to the accompanying drawings in which:

FIG. 1 is a diagram of a motor vehicle according to one embodiment of the invention for muting the audio system in response to an incoming call to a wireless device;

FIG. 2 is a circuit diagram of selected elements of the motor vehicle of FIG. 1; and

FIG. 3 is a logic diagram of selected elements of the motor vehicle of FIG. 1.

While the invention is susceptible to various modifications and alternative forms, specific embodiments thereof are shown by way of example in the drawings and will herein be described in detail. It should be understood, however, that the drawings and detailed description presented herein are not intended to limit the invention to the particular embodiment disclosed, but on the contrary, the intention is to cover all modifications, equivalents, and alternatives falling within the spirit and scope of the present invention as defined by the appended claims.

### DETAILED DESCRIPTION OF THE INVENTION

Generally speaking, the present invention contemplates an audio system, such as the audio system present in most motor vehicles, which responds to selected incoming wireless device signals by muting or otherwise altering the audio system's playing mode. When an incoming signal to a wireless device is detected, the audio system responds by muting the audio system thereby preventing the motor vehicle occupant from having to manually adjust the audio system volume. The disclosed audio system thereby provides a significant automation and safety feature to the motor vehicle.

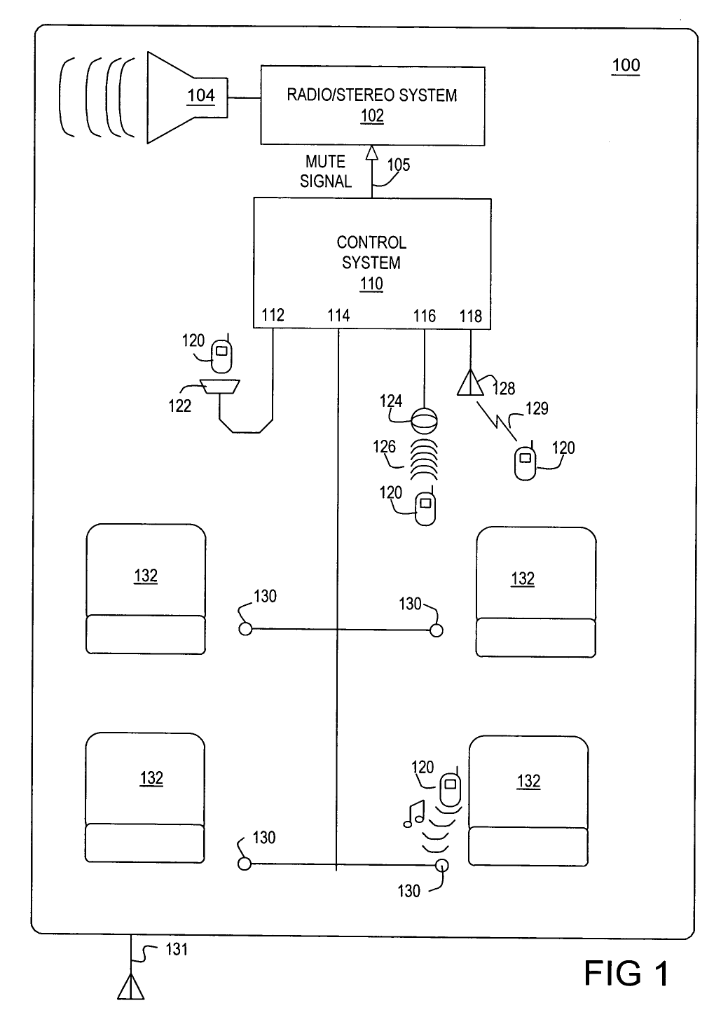

Turning now to the drawings, FIG. 1 illustrates selected elements of a motor vehicle 100 having an audio system 102, according to an embodiment of the present invention, that is designed and enabled to respond to the detection of various signals or stimuli by automatically muting the audio system output. The invention is intended to encompass implementations using a variety of different stimulus, examples of which are envisioned by the depicted implementation. More specifically, the invention is intended to include implementations that rely on radio frequency signals, audio signals, infrared signals, and digital signals as the trigger that initiates the muting of the audio system. The illustrated example of motor vehicle 100 includes devices to handle all of these different types of signals. In other implementations, cost savings may be realized by including hardware capable of handling just one or a few of these types of signals. In the following text, the depicted wireless device used in conjunction with the present invention is a cellular telephone. The invention, however, is applicable for use with wireless communication devices generally. Such devices include, for example, wireless pagers as well as personal digital assistants (PDA's) and pocket PC's having wireless capabilities.

As depicted in FIG. 1, motor vehicle 100 includes an audio system 102 that drives one or more speakers 104. A control system 110 is configured to assert a mute signal 105 that is provided to the audio system under prescribed circumstances. In addition, control system 110 includes a set of signal input ports 112, 114, 116, and 118, for receiving various types of input signals from two or more wireless communication devices, each of which may result in the assertion of mute signal 105. Other embodiments of the invention may include a control system 110 having any one or any combination of the signal input ports 112 through 118.

A first signal input port 112, referred to herein as the digital input port, is shown as connected to a cradle 122 via an intermediate cable or wire. Cradle 122 is designed to receive a cellular or wireless telephone 120. Cradle 122 is typically a phone specific cradle that is sized to and includes connectors for the specific make and model of phone 120. Phone 120, in an embodiment suitable for use with digital input port 112, is configured to assert an externally accessible signal when an incoming call to the cellular telephone is received and, perhaps, during the time when the ensuing conversation is in progress. Cradle 122 includes a connector that contacts the externally accessible phone signal and conveys the externally accessible phone signal to digital input port 112 over the intermediate cable or wire. Control system 110 includes logic or other means to assert mute signal 105 in response to the assertion of the signal provided to digital input port 112. The signal provided to digital signal input port 112, in various embodiments, is a digital signal that may include a single bit or multiple bits of information. In a single bit implementation (desirable for its ease of implementation and cost), the digital input port is designed to interpret the signals as a switch signal for mute signal 105. In multiple bit implementations, the digital input port 112 may receive additional information provided by the phone 120. This information could include, for example, the caller's phone number and other information that may be used to make decisions about whether to assert mute signal 105 (e.g., mute audio system depending upon the caller's identity). At a minimum, however, control system 110 is designed to respond to the signal received by digital input port 112 by generating mute signal 105 to adjust or mute the audio output produced by audio system 102.

Control system 110 as depicted in FIG. 1 also includes an audio input port 114. Audio signal input port 114 is shown as connected to a set of audio detectors (e.g., microphones) 130. Audio detectors 130 may be placed within the vehicle 100 in position most likely to be in proximity to a ringing or beeping cell phone or pager. Thus, as an example, an audio detector 130 may be positioned within or near each seat 132 of the vehicle. In the audio input embodiment, a user of the system would likely have to train or teach audio system 110 the sound to which it should respond by muting the radio. The user would have to transition control system 110 to a learn mode by, for example, pressing a predetermined sequence of numbers using audio system's “channel” buttons. After successfully placing the control system 110 in learn mode, the user would then place the phone near one of the audio detectors and force the phone to ring as it would ring in response to an incoming call. Control system 110 receives the audio signal via an audio detector 130 through input port 114, converts it to a digital format, and stores the digital representation of the ringing cell phone. When not in learn mode, control system 110 is configured to use digital signal processing (DSP) techniques to compare the sounds received via audio inputs 130 to the sound of the ringing cell phone. If a match is detected between sound received via audio input port 114 and the stored representation of the ringing cell phone, the control system 110 would respond by asserting mute signal 105 to mute or alter the audio system output.

Infrared signal input port 116 and radio frequency signal input port 118 are configured for use with an infrared signal generator and a radio frequency signal generator of phone 120. In response to receiving an incoming call, cell phone 120 may generate an infrared signal such as an IrDA compliant signal or a short range (i.e., less than approximately 50 meters) radio frequency signal such as a Bluetooth® or WiFi (IEEE 802.11) compliant signal. These signals are received by infrared signal input port 116 and radio frequency signal input port 118 through sensors 124 and 128, respectively. Control system 110 responds to these infrared and radio frequency signals by asserting mute signal 105. Like the digital signal described with respect to digital input signal port 112, the infrared and radio frequency signals may range from single bit implementations that merely switch on the mute signal 105 to more complex implementations capable of conveying additional information including the caller's identity or phone number to enable the control system to make “smart” decisions about generating mute signal 105 such as caller dependent muting. In the case of infrared, the depicted embodiment of cell phone 120 produces an infrared signal 126 when the phone 120 is ringing or otherwise announcing an incoming call. Infrared signal 126 is transmitted to an infrared receiver 124 that is connected to or integrated within input port 116. Analogously in the case of a radio frequency signal such as a Bluetooth or WiFi signal, phone 120 generates a radio frequency signal 129 that is detected by a control system antenna 128.

In any of the implementations represented by digital signal input port 112, infrared signal input port 116, or radio frequency signal input port 118, the control system 110 is configured to monitor or check the status of the signal that caused the assertion of mute signal 105. When this signal is detected as being de-asserted or terminated, one embodiment of control system 110 resumes the audio system volume that was playing prior to being muted. In the case of audio signal input port 114, however, the mute signal 105 may be asserted until deactivated by the user following an incoming call because the cell phone 120 may not be capable of generating a sound at the end of the phone call.

Any of the implementations represented by digital signal input port 112, infrared signal input port 116, or radio frequency signal input port 118, may be used in conjunction with user-selectable phone number preferences that specify which cell phones are authorized to initiate the automated audio system muting functions described herein. In these embodiments, the user would likely enter a setup mode of control system 110 through the audio system keypad. While in the setup mode, the user would then specify one or more phone numbers that are authorized to initiate the automated muting. In these embodiments, control system 110 would verify the identity of the cell phone being called prior to initiating the call muting process.

In another embodiment, control system 110 is configured to detect an incoming phone call directly. In one such embodiment, a user is able to indicate one or more cell phones authorized to perform the auto muting, possibly using the existing set of keys on the audio system itself. When a signal transmitted by a wireless service provider and indicating an incoming call is detected by cell phone 120, the transmitted signal is simultaneously detected by control system 110 either through its local antenna 128 or through the external antenna 131 of the motor vehicle 100, to which the control system is coupled. This direct detection implementation offers improved performance over the other implementations because the detection of the incoming call by the cell phone 120 occurs in parallel with the detecting of the incoming call by control system 110. Moreover, by leveraging the external antenna for detecting incoming cell phone calls, this implementation may require the fewest modifications to existing audio systems hardware. In this implementation, the user would enter a setup mode using the audio system keypad. Within the setup mode, the user would then specify one or more cell phone numbers with which the system is concerned. When an incoming call is detected by cell phone 120, the call is also detected by antenna 128 or 131 and processed to determine whether to mute the audio system or not.

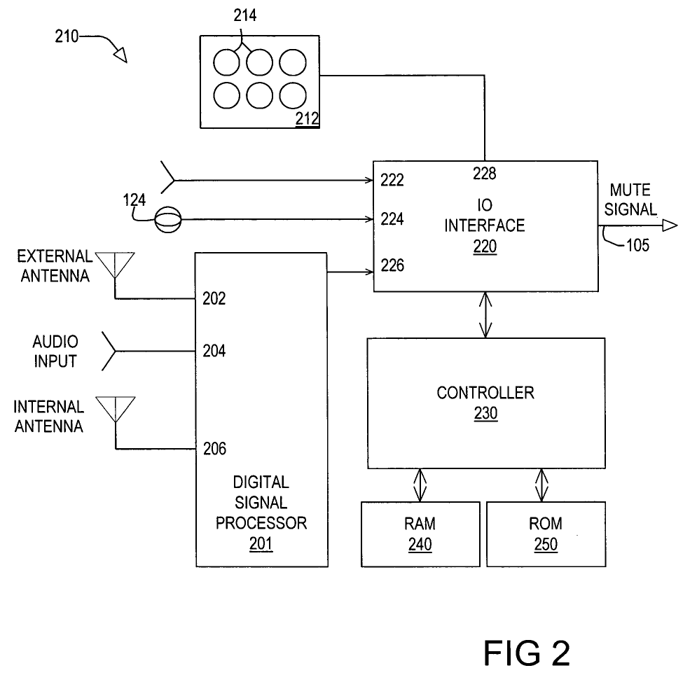

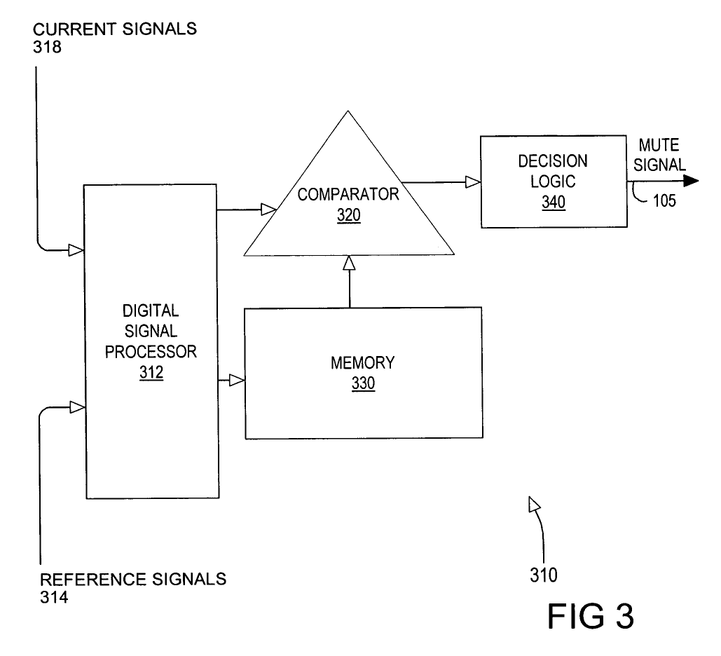

Turning now to FIGS. 2 and 3, a circuit diagram and logic diagram respectively of a control system 210 and 310 are shown to emphasize additional details of the present invention. The depicted embodiment of control system 210 includes a keypad 212 and a set of keys 214 that enable the user to provide input (such as a set of recognized or authorized cell phone numbers) to control system 210. An interface logic unit 220 includes ports 222, 224, 226, and 228 for receiving a digital input signal, an infrared input signal from an infrared receiver 124, an output of a DSP 201, and an output from keypad 212. DSP 201 includes ports 202, 204, and 206 for receiving signals via an external antenna 131, an audio input 114, and an internal antenna 206. DSP 201 is configured to process received signals and to provide a digital output signal derived from the received signal. The DSP output signal is provide to interface unit 220. A controller 230 is connected to interface 220 and is designed to determine which, if any, of the information received by interface 220 results in the assertion of mute signal 105 and the resulting automated muting of the audio system. Controller 230 has access to RAM and ROM storage devices 240 and 250. ROM 250 likely includes the code used by controller 230 to perform its basic functions. RAM 240 may be used to stored items such as the digital representation of a ringing phone as well as the phone numbers of authorized users of the system.

As shown in FIG. 3, an embodiment of a control system 310 suitable for use as control system 110 of FIG. 1 is shown to illustrate the control system's functional behavior. In the depicted embodiment, a DSP 312 of control system 310 is configured to receive “current” or live signals represented by reference numeral 318 as well as reference signals, which may have been previously learned by the system and stored in memory. DSP 312 processes the set of live signals 318 to produce digital values that are provided to a comparator 320 and possibly to a memory unit 330 (for later use). Comparator 320 determines whether there is a match between current signals 318 and reference signals 314 and provides the outcome of its determination to decision logic 340. The decision logic then determines whether to assert the mute signal in response to a detected match between current signals 318 and reference signals 314.

It will be apparent to those skilled in the art having the benefit of this disclosure that the present invention contemplates an audio system that responds to selected incoming phone calls as described. It is understood that the form of the invention shown and described in the detailed description and the drawings are to be taken merely as presently preferred examples. It is intended that the following claims be interpreted broadly to embrace all the variations of the preferred embodiments disclosed.

1. An assembly suitable for use in a motor vehicle, comprising:
an audio system including at least one speaker, the audio system being enabled to receive a mute signal and to respond to the mute signal by muting the audio system output;
a control system coupled to the audio system and enabled to respond to a signal indicative of an incoming call or message to any of two or more wireless devices within the motor vehicle by asserting the mute signal to mute the output of the audio system.

2. The assembly of claim 1, wherein the indicative signal is a ringing signal produced by any of the two or more of the wireless devices and wherein the control system includes an audio input to detect the ringing signal.

3. The assembly of claim 2, further comprising a set of audio detectors positioned within the vehicle to detect the ringing of any of the wireless devices, each of the audio detectors being coupled to the audio input port.

4. The assembly of claim 2, wherein the control system is further enabled to learn characteristics of the ringing signal of a particular wireless device, and wherein the control system is enabled to respond with the mute signal selectively to learned ringing signals.

5. The assembly of claim 1, wherein the indicative signal is generated by the wireless communication device in response to the wireless device receiving an incoming call or message.

6. The assembly of claim 5, wherein the indicative signal is a non-audible signal.

7. The assembly of claim 6, wherein the non-audible signal comprises an infrared signal and further wherein the control system includes an infrared port enabled to receive the infrared signal.

8. The assembly of claim 6, wherein the non-audible signal comprises a radio frequency signal and further wherein the control system includes an antenna suitable for receiving the radio frequency signal.

9. The assembly of claim 8, wherein the radio signal is a Bluetooth compliant signal.

10. The assembly of claim 6, wherein the indicative signal is a digital signal transmitted from the wireless device to the control system via a cable connecting at least one of the wireless devices to a digital input port of the control system.

11. The assembly of claim 1, wherein the indicative signal is a signal transmitted to any of the wireless devices by a wireless service provider and further wherein the control system is enabled to detect the transmitted signal.

12. The assembly of claim 11, wherein the control system includes means for enabling a user to specify telephone numbers of wireless devices to define the set of wireless devices for which the control system asserts the mute signal.

13. A wireless communication device including means for transmitting a radio frequency signal, to mute an audio system in proximity to the wireless communication device, responsive to the wireless device receiving an incoming call or message.

14. The wireless communication device of claim 13, wherein the radio frequency signal generated by the wireless device has a range of less than 50 meters.

15. The wireless communication device of claim 13, wherein the radio frequency signal comprises a Bluetooth compliant signal.

16. The wireless communication device of claim 13, wherein the radio frequency signal comprises a WiFi compliant signal.

17. The wireless communication device of claim 13, wherein, in addition to indicating the incoming call or message, the radio frequency signal generated by the wireless device is indicative of the phone number from which the call or message originated.

18. An assembly within a motor vehicle, comprising:
means for detecting a signal generated by any of two or more wireless communication devices responsive to receiving an incoming call or message; and
means for muting an audio system of the motor vehicle responsive to the detecting means.

19. The assembly of claim 18, wherein the generated signal comprises a signal selected from the set of signals consisting of an audible signal, an infrared signal, and a short range radio frequency signal.

20. The assembly of claim 18, wherein the means for detecting are further characterized as means for detecting a signal generated by a selected wireless communication device.

21. The assembly of claim 18, wherein the means for muting the audio system include means for restoring the audio system responsive to termination of the incoming call or message.
